(19) United States
(12) Patent Application Publication
(10) Pub. No.: US 2022/0032568 A1
(43) Pub. Date: Feb. 3, 2022

(54) Assembly of a Pellet Press and a Pellet Breaking Device Mounted on the Pellet Press Breaking Device

(71) Applicant: CPM Europe B.V., Zaandam (NL)

(72) Inventors: Jan-Willem van Lindenberg, Weesp (NL); Lukas Meijer, Ouderkerk aan de Amstel (NL); Maurice Bindels, Amersfoort (NL)

(21) Appl. No.: 17/487,499

(22) Filed: Sep. 28, 2021

Related U.S. Application Data
(63) Continuation of application No. PCT/NL2020/050287, filed on May 6, 2020.

(30) Foreign Application Priority Data
May 8, 2019 (NL) 2023087

(51) Int. Cl. B30B 11/22

(52) U.S. Cl. CPC B30B 11/227

(57) ABSTRACT

An assembly of a pellet press and a pellet breaking device mounted on the pellet press, the pellet press being equipped with a cylindrical outer wall that is provided with a series of radial through holes for radially and outwardly pressing the pellets from within the press towards and away from an outer circumferential contour of the pellet press, wherein the breaking device encircles the pellet press at a predefined distance from the outer circumferential contour of the pellet press, and that the plate is equipped with a series of slits providing to the pellets a release-way away from the pellet press, wherein the slits span at least a part of the outer circumferential contour of the pellet press along an area that is provided with the through holes, and wherein the slits are provided in two series with mirror image orientations that are pointing towards each other.

### CROSS-REFERENCE TO RELATED APPLICATIONS

This application is a continuation application of PCT/NL2020/050287, titled “AN ASSEMBLY OF A PELLET PRESS AND A PELLET BREAKING DEVICE MOUNTED ON THE PELLET PRESS BREAKING DEVICE”, filed on May 6, 2020, which claims priority to and the benefit of Netherland Patent Application No. 2023087, titled “AN ASSEMBLY OF A PELLET PRESS AND A PELLET BREAKING DEVICE MOUNTED ON THE PELLET PRESS BREAKING DEVICE”, filed on May 8, 2019, and the specification and claims thereof are incorporated herein by reference.

### BACKGROUND OF THE INVENTION

### Field of the Invention

Embodiments of the present invention relate to an assembly of a pellet press and a pellet breaking device mounted on the pellet press, said pellet press being equipped with a cylindrical outer wall that is provided with a series of radial through holes for radially and outwardly pressing the pellets from within the press towards and away from an outer circumferential contour of the pellet press, wherein said breaking device is provided at a predefined distance from the outer circumferential contour of the pellet press.

### Background Art

EP-A-2 727 715 discloses a pellet breaking device. The known pellet breaking device is equipped with pellet cutting means and at least one attachment region in which the cutting means are attached on a fixed housing part of the pellet press such that the cutting means can be arranged at a predefined space from the pellet press. The cutting means has a concave arcuate contour which is substantially helical over at least a region of one of the radial through-holes of the ring die of the pellet press, so that a pellet, via the ring die in the radial direction and with a greater length than the distance between the ring die and the cutting means protrudes from the through hole, then in the region of its free end comes to rest on a base body with a concave circular-arc radial guide surface on which the cutting means is mounted, and can move along the circumferential direction of the base body such that the pellet is deflected by the cutting means by means of a force having an axial component, so that the pellet kinks in the region of the ring die.

The present invention departs from and improves upon the complicated and heavy design known from EP-A-2 727 715. The present invention provides a pellet breaking device which is contrary to the known device and which is energy-efficient and reliable in providing pellets of well-defined length within a limited length-range to meet the demands of manufacturing pellets to be used as feedstock for living animals. In one embodiment, a maximum length of such pellets is preferably approximately 5 mm with 2-3.5 mm diameter, or a maximum of 20 mm with 2-8 mm diameter. This type of pellets is suitable for feedstock for living animals and cannot be manufactured with the device known from EP-A-2 727 715. The reason is that this known device cannot handle the capacity and length as required for manufacturing pellets which are to be used as feedstock for living animals.

The pellets have to be of limited length, but a problem in the prior art when manufacturing those limited length pellets is that a lot of fines are produced which is detrimental for the energy efficiency of the process.

It is therefore an object of the present invention to provide a pellet breaking device for manufacturing pellets with the mentioned limited length, wherein the not intended production of fines is as much as possible prevented.

Another object of the present invention is that by reducing the production of fines, the overall capacity of the pellet breaking device of the invention for the production of pellets is increased, since there are less fines required to feed back into the manufacturing process, and the energy consumption per unit of manufactured pellets can be accordingly lowered.

FR 3 028 446 discloses a machine for manufacturing granules by pressing a pulverulent material, said machine comprising a frame defining an enclosure; a perforated annular die mounted in the enclosure and driven in rotation relative to the frame; at least one pressure roller mounted in the die in the vicinity of an internal face thereof; and a device for cutting granules comprising a grid which extends at least partially around the die opposite an external face thereof.

### BRIEF SUMMARY OF THE INVENTION

A pellet breaking device of an embodiment of the present invention has the features of one or more of the appended claims.

In a first aspect of the present invention, a breaking device comprises a plate encircling the pellet press at a predefined distance from the outer circumferential contour of the pellet press, and that said plate is equipped with a series of slits providing to the pellets a release-way away from the pellet press, wherein said slits span at least a part of the outer circumferential contour of the pellet press along an area that is provided with said through holes, and that the slits are provided in two series with mirror image orientations that are pointing towards each other, wherein said slits that are pointing towards each other in different orientations enclose an angle between the slits in a range between 60 and 80°. Particularly this angle is found beneficial to assure a gentle, partly side-ways, breaking action of the pellets, thus reducing the fines and improving the pellet quality.

The plate has the functionality to smoothly break the pellets when they leave the through holes of the pellet press while they are still hot. This reduces the production of fines which conventionally occurs when the pellets are broken after they are cooled down. The slits in turn provide a release way for the broken pellets, that have just escaped from the through holes in the pellet press and are broken by the action of the plate. Providing the slits in two series with mirror image orientations enable the cut pellets to divert to two distinct directions, instead of all going to the same side, thus reducing contact between said pellets and minimalizing damage to the pellets. This promotes the reduction of fines and improves the pellet quality.

Preferably the slits in each series are mutually parallel.

To secure a high enough production capacity of the pellet press on which the pellet breaking device is mounted, the slits have a width spanning at least three neighbouring through holes.

It is found advantageous that the slits are obliquely oriented with reference to a longitudinal body axis of the pellet press. This promotes the gradual release of the broken pellets from the pellet press.

In order to be able to manufacture pellets with variable length it is preferable that the distance at which said plate encircles the pellet press is adjustable.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is an illustration from an isometric view of a pellet press provided with a pellet breaking device according to an embodiment of the present invention;

FIG. 2 is an illustration from a side view of a pellet breaking device according to an embodiment of the present invention; and

FIG. 3 is an illustration from an oblique view of a pellet breaking device according to an embodiment of the present invention.

### DETAILED DESCRIPTION OF THE INVENTION

Whenever in the figures the same reference numerals are applied, these numerals refer to the same parts.

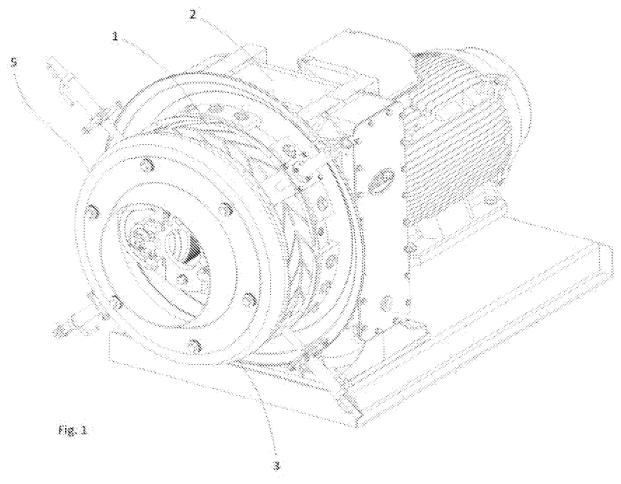

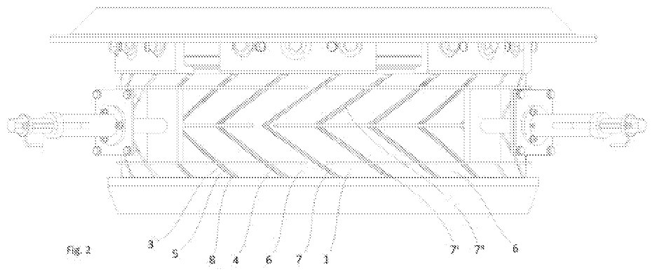

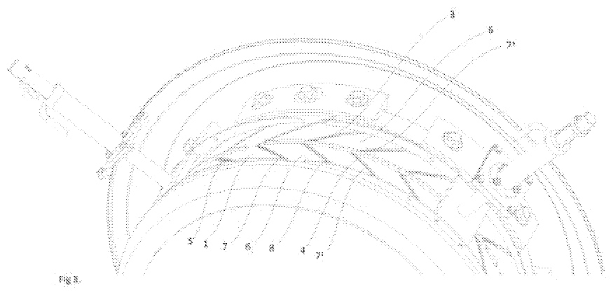

FIG. 1 shows pellet breaking device 1 mounted on pellet press 2, pellet press 2 being equipped with cylindrical outer wall 3. FIGS. 2 and 3 provide a view at cylindrical outer wall 3 underneath pellet breaking device 1, wherein it is shown that cylindrical outer wall 3 is provided with a series of radial through holes 4 for radially and outwardly pressing the pellets from within press 2 towards and away from outer circumferential contour 5 of pellet press 2.

Breaking device 1 is provided at a predefined distance from the outer circumferential contour 5 of pellet press 2, and comprises plate 6 encircling pellet press 2 at said predefined distance from outer circumferential contour 5 of pellet press 2. Plate 6 is equipped with a series of slits 7 providing to the pellets a release-way away from pellet press 2, wherein slits 7 span at least a part of outer circumferential contour 5 of pellet press 2 along area 8 that is provided with through holes 4. It is remarked that the distance at which plate 6 encircles pellet press 2 is adjustable.

It can be seen in FIG. 2 and in FIG. 3 that slits 7 have a width spanning at least three neighbouring through holes 4.

It is clear from both FIG. 2 and FIG. 3 in combination with FIG. 1 that slits 7 are preferably obliquely oriented with reference to a longitudinal body axis of pellet press 2.

Further it shows that slits 7 are provided in two series 7′, 7″ with mirror image orientations that are pointing towards each other, and that slits 7 in each series 7′, 7″ are mutually parallel. Further it is remarked that slits 7 that are pointing towards each other in different orientations enclose an angle between slits 7 in a range between 60° and 80°.

Although the invention has been discussed in the foregoing with reference to an exemplary embodiment of the pellet breaking device of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Note that in the specification and claims, “about” or “approximately” means within twenty percent (20%) of the numerical amount cited.

1. An assembly comprising a pellet press and a pellet breaking device mounted on the pellet press:
the pellet press comprising a cylindrical outer wall comprising a series of radial through holes for radially and outwardly pressing the pellets from within the press towards and away from an outer circumferential contour of the pellet press; and
the breaking device comprising a plate encircling the pellet press at a predefined distance from the outer circumferential contour of the pellet press, and that the plate is equipped with a series of slits providing to the pellets a release-way away from the pellet press, wherein the slits span at least a part of the outer circumferential contour of the pellet press along an area that is provided with the through holes, wherein the slits are provided in two series with mirror image orientations that are pointing towards each other, and wherein the slits that are pointing towards each other in different orientations enclose an angle between the slits in a range between about 60° and about 80°.

2. An assembly according to claim 1, wherein the slits in each series are mutually parallel.

3. An assembly according to claim 1, wherein the slits have a width spanning at least about three neighbouring through holes.

4. An assembly according to claim 1, wherein the slits are obliquely oriented with reference to a longitudinal body axis of the pellet press.

5. An assembly according to claim 1, wherein the distance at which said plate encircles the pellet press is adjustable.
